(19) United States
(12) Patent Application Publication
(10) Pub. No.: US 2002/0169858 A1
(43) Pub. Date: Nov. 14, 2002

(54) Broadband network service delivery method and device

(76) Inventors: Doug Bellinger, Ottawa (CA); Richard Burke, Vanier (CA); Pat Rhude, Dunrobin (CA); Tom Phillips, Ottawa (CA); Geoff Stewart, Ottawa (CA); Wendy Raoux, Ottawa (CA)

Correspondence Address: MARKS & CLERK, P.O. BOX 957, STATION B, OTTAWA, ON, K1P 5S7, CA

(21) Appl. No.: 09/852,708

(22) Filed: May 11, 2001

(51) Int. Cl. G06F 15/177; G06F 15/173

(52) U.S. Cl. 709/220; 709/223

(57) ABSTRACT

A central Service Creation Platform (SCP) is located at the service provider's premises. The SCP gives service providers a common platform from which to create and deploy new services, manage services, and record and aggregate billing records. The SCP includes a (Lightweight Directory Access Protocol) LDAP database that stores policies associated with the various distributed network elements. The SCP is connected to Service Delivery Agents (SDAs) distributed throughout the network, which in turn are connected to Managed Elements (MEs). The MEs are hardware or software elements that provide the services to users. The SDAs control the MEs and, depending on the type of ME, can monitor the activity of the ME.

### BACKGROUND OF THE INVENTION

1. Field of the Invention

The present invention relates generally to digital communications networks, and in particular to the delivery and management of services over such networks. More specifically, the present invention relates to a method and system for the creation, delivery and management of communications, computer applications, content and other services over broadband networks that are targeted to specific customers or groups of customers from a central location, and a method of communicating with diverse equipment using a common language.

2. Description of Related Art

Broadband networks are communication networks that allow the transmission of large amounts of data, including voice and video, at high speed. With the advent of broadband networks, customers are demanding more and more services that require high bandwidth (high rates of data throughput). Of these services, the best known is probably broadband or high speed Internet access; however, there are other types of services such as video on demand and television transmission, as well as a number of other computer-and communications-related applications, including voice-over-IP, ERP application management, streaming media etc.

At the same time, there has been a growing number of competing service providers offering broadband access services, including traditional telephone carriers, long distance carriers, community local exchange carriers (CLECs), building local exchange carriers (BLECs), as well as Internet service providers (ISPs) and application service providers (ASPs).

As broadband capacity has increased, the cost of high speed Internet access and other broadband services has fallen drastically. In some cases, access is offered for free in order to attract customers for other value added services offered by the service provider. Accordingly, it is evident that service providers will not be able to operate at a profit by offering high speed Internet access alone, particularly in view of significant capital investments that have been made by many service providers.

In order to attract new customers and to generate new sources of revenue, service providers must offer more value added services, and they must be able to provide those services effectively and efficiently. Markets with high revenue potential are those where there are groups of end users with common or similar service requirements sharing a common network infrastructure that is capable of delivering broadband network access, which makes possible efficient bundling of services. Examples of such markets include multi-tenant unit (MTU) buildings, multi-dwelling unit (MDU) residential buildings, hotels, hospitals, business and university campuses and dormitories.

In order to develop these markets and to avoid becoming a commodity provider, service providers must be able to offer a range of services suited to the specific needs of end users and groups of end users in order to attract new subscribers and to retain existing ones. In addition to data services, these include things like local, long distance and mobile telephone services, software applications, localized content, security monitoring and intrusion detection, billing services, and other managed IT offerings such as voice over DSL, virtual private networks (VPNs), Internet conferencing, firewalls, server backup, etc. At present, service providers lack the tools to efficiently and economically create and deploy these types of new services as new technologies become available and in response to the requirements of individual users. When a new service becomes available, service providers must be able to acquire the equipment and have the ability to offer the service to their customers as rapidly as possible without the need for extensive reconfiguration and on-site visits. For example, a service provider acquiring new application server needs to be able to quickly make its services available to eligible subscribers along with the necessary billing and other ancillary requirements. An object of the invention is to achieve this goal.

### SUMMARY OF THE INVENTION

In accordance with a first aspect the invention provides a system for managing the delivery of services over a network, comprising a plurality of distributed network entities configurable to deliver specified services; a plurality of service agents operable to configure one or more of said distributed network entities associated therewith in response to messages received at a generic interface; and a central controller for generating said messages using a common instruction set for all said network entities, said central controller including a database storing attributes defining the configuration of said network entities.

In a typical embodiment the central controller is a Service Creation Platform (SCP) located at the service provider's premises and providing a common platform from which service providers can create and deploy new services, manage services, and record and aggregate billing records. The SCP is connected to Service Delivery Agents (SDAs) distributed throughout the network, which in turn are connected to Managed Elements (MEs). The MEs are hardware or software entities that provide the services to users. The SDAs control the MEs and, depending on the type of ME, can monitor the activity of the ME. An ME could be a firewall or an application providing web services, for example.

When a new service is to be implemented or added to the network, the service provider installs a service driver. Like device drivers for personal computers, the service drivers generate technology specific instructions to implement policies stored on the SCP. Once the service has been defined on the SCP, the SCP downloads configuration information to the SDAs associated with the MEs that will deliver the service using a generic, common interface located at the SDA. The SDAs then pass the required configuration information to the ME in a form compatible with the ME in order to install the service. For example, if the ME is a router, the SDA would use a standard protocol such as SNMP or IOS to configure the router.

In addition to configuring MEs for new services, SDAs are also provided with the policies required to manage the ME by the SCP. This allows the SDAs to activate and deactivate services, enforce policies, authenticate users, and gather statistics required for billing purposes and system maintenance. Similarly, the SCP can upgrade, back-up and restore the SDA. The service drivers can be created by the service provider or by third parties.

Communication between the SCP and SDA is carried out using a common language, such as XML. Messages are transported over the network using secure http or a similar protocol. The advantage of XML over https is that it allows for secure transfer of data over the Internet, thereby avoiding the need to set up dedicated management network between the service provider's operation center and each customer location in order to manage the SDAs. The use of SDAs provides service providers with the flexibility to manage different types of equipment by using the appropriate service driver at the SCP.

When the SCP receives a service activation request from or on behalf of a subscriber, the SCP authenticates and checks whether the service is available to the subscriber based on pre-established policies or rules. If the service is available to the subscriber, the SCP sends a service configuration request to the specific SDA that is connected to and manages the ME associated with that service and subscriber. The SDA then configures that ME with the required data to allow the service to be activated. The SDA may be software hosted on the same platform as the ME or on an entirely separate physical platform. It may be located at or near the SCP or at some location intermediate to the SCP and ME.

MEs are typically located at customer premises and could include devices such as routers, PBXs, firewalls. MEs can also be situated at locations remote from the customer premises, but connected to the customer premises. For example, a web or news server connected to the user over the Internet.

Another aspect of the invention is the use of portal servers to provide an interface between individual users or groups of users through an administrator and the SCP. Using a web browser, a user accesses a portal server that has been established by the service provider. A login procedure is provided for whereby the user enters certain login information. The portal server then passes the information to the SCP which authenticates the login request and identifes the user. The SCP provides the portal server with user information from which the portal server displays the service offerings available to that user. The user can then activate, modify or deactivate specified services. If, for example, the user selects a service activation, the portal server sends the activation request to the SCP. The SCP performs any authentication or policy checking (in accordance with the policies set up by the service provider for that user). The SCP then sends a service configuration request to the appropriate SDA. The SDA reconfigures the ME to provide the appropriate service to the user. Again, in accordance with policies communications from the SCP, the use of the service can be monitored and statistics recorded, which are returned to the SCP for billing records.

In a still further aspect the invention provides a method of controlling the delivery of services to customers over a network, comprising the steps of providing a plurality of distributed network entities capable of providing services to customers connected thereto; providing at each of said distributed network entities a service agent responsive to commands using a common instruction set received at a generic interface to configure said network entities; providing a central controller for generating said commands to configure said network entities; storing in a database associated with said central controller policy attributes determining the configuration of said network entities; and sending said commands to said network entities to configure said network entities in accordance with policies established in said central controller.

In yet anther aspect the invention provides a method of managing a plurality of network elements to define service offerings from a central location, comprising storing in a computer a model identifying service offerings, users, and delivery points; defining within said model specific service offerings using a common language; receiving service requests for offerings from identified users in said common language and inputting said requests into said model; configuring said model using said common language to implement said service requests within said model; and forwarding instructions in said common language from said model to service drivers associated with said network elements, said service drivers translating said instructions in said common language into hardware specific instructions associated with said network elements in order to implement said service requests.

The common language is preferably XML generated from XSL style sheets which define the underlying presentation and structure.

This use of a model with a common language defining the service policies has the important advantage of flexibility. A service provider can define policies, publish these policies to specific users, and act on requests from users to activate publishes policies entirely in software. Each user can access a list of policies published to that user. The model generates instructions in the common language, which are then passed to the service drivers to implement in the hardware specific language of the local managed element. The entire definition of service offerings and implementation can be carried out in software by the central authority, typically an ISP. In order to change service offerings or implement new policies, it is merely necessary for the ISP to make the necessary changes to the model using XML documents. Whenever a hardware element is added to the network, all that is required is that it be provided with a service driver to establish communication between the hardware element and the central authority. This will often be provided by the manufacturer, for example, CISCO, based on published specifications in much the same way as a printer manufacturer will supply a service driver to work with different operation systems; for example, Hewlett-Packard might supply a driver with a printer to work with the Windows™ operating system.

### BRIEF DESCRIPTION OF DRAWINGS

FIG. 1 is a diagram illustrating the basic architecture of a service delivery system in accordance with one embodiment of the present invention;

FIG. 2 is a block diagram of a service delivery point.

FIG. 3 is shows the LDAP directory structure of the database in the central controller;

FIG. 4 is a sample configuration XML document;

FIG. 5 shows changes to the LDAP directory after installation of a new firewall and corresponding service drivers;

FIG. 6 shows the changes to the LDAP directory after installation of a new service offering;

FIG. 7 shows a form for the configuration of a firewall service;

FIG. 8 shows the representation of customers in an LDAP directory;

FIG. 9 shows the creation of distinct service offerings for different customers;

FIG. 10 is an example of a service registration document;

FIG. 11 illustrates how a customer sends a service request to the central controller; and

FIG. 12 shows an architecture of a service delivery system including a remote subcontroller.

FIG. 13 is an overview of a directory tree structure forming part of a computer model in accordance with one embodiment of the invention.

FIG. 14 shows a specific directory tree structure for defining services.

FIG. 15 shows a specific directory tree structure for defining users.

FIG. 16 shows a specific directory tree structure for defining service delivery points.

FIG. 17 shows an XML document defining a service offering.

FIG. 18 illustrates the activation of a particular service offering.

FIG. 19 shows the activation of a registration policy for a particular service offering.

FIG. 20 shows an activation policy for a particular service offering.

FIG. 21 is an example of a service driver configuration stored in the computer model using XML documents.

FIG. 22 is a specific example of a service driver configuration.

### DESCRIPTION OF THE PREFERRED EMBODIMENTS

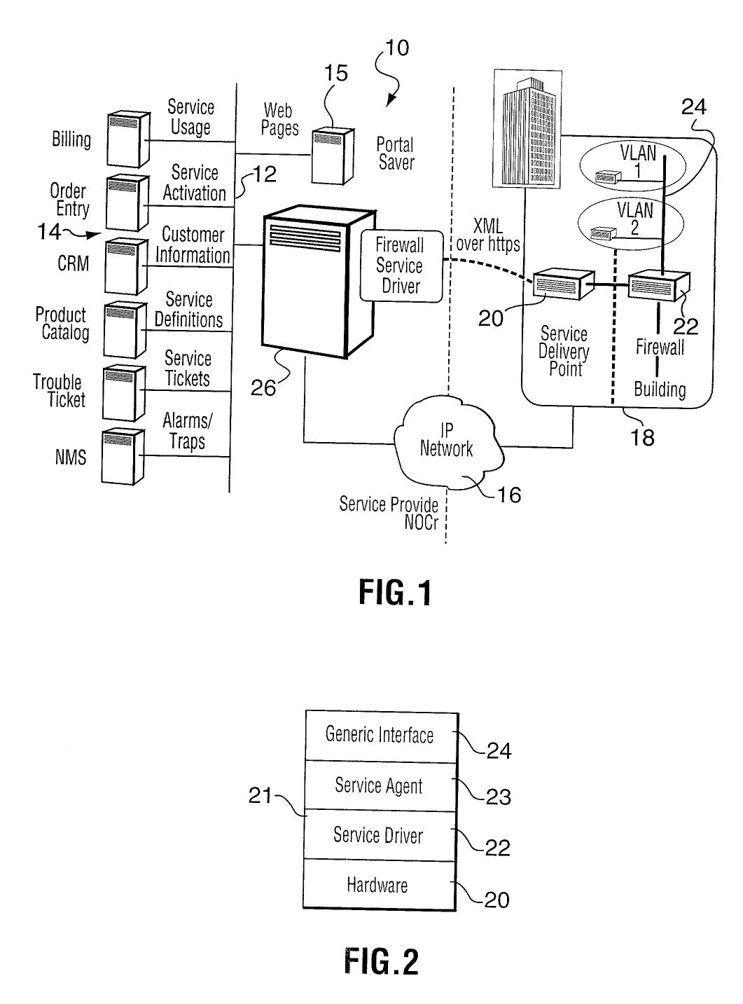

A typical configuration of a service delivery system in accordance with the invention is shown in FIG. 1. A network operations center (NOC) 10 of an Internet Service Provider (ISP) has a local area network (LAN) 12 connected to servers 14 offering various services, such as billing, service activation, customer activation, service definitions, service tickets, and trouble definitions. The NOC 10 is connected to an IP network 16, typically the Internet.

A service delivery point (SDP) is located at a remote location 18, which could be an office tower, hotel, multi-tenant unit or the like. In this example, the SDP comprises a computer 20 connected through a firewall 22 to a local virtual LAN 24. Although only one SDP is shown, it will be appreciated that a number of such points are distributed over the service area of the ISP. The SDPs typically reside on the premise of a small office, in the basement of a building or hotel, or in the service providers point of presence (POP). They may be connected to the Internet via a high-speed broadband connection, for example, DSL, wireless, optical, cable etc. and act as a gateway between the subscriber and the services being offered by the service provider. An advantage of providing the SDPs close to the users is that service providers have a more scaleable solution and users benefit from faster response times.

The SDPs are managed AAA (authentication, authorization and accounting) servers, which reside close to the end user. Examples of the services offered to local customers by the SDPs are: Internet access, firewall, VPN, intrusion detection, and meeting room scheduling. They can include communications or computing devices (e.g. PDFs, Firewalls, VPN servers etc.)

The SDPs are responsible for enforcing policies determined by a central “authority” or controller 26, authenticating users, delivering service portals that permit customers request specific services, activating requested services, and correlating service usage information and reporting service outages to the central authority.

Service drivers normally run on the SDPs 20 although they can run on the central authority. The disadvantage of the latter arrangement is that commands sent to the SDPs must be sent using a language specific to each hardware element at the SDP. The service drivers are technology specific drivers that communicate with the central authority using a common language, preferably XML. They are similar to device drivers in a PC in that they generate the instructions required to cause a piece of hardware (or software) to carry out a desired action in response to commands sent in a common language, which in the preferred embodiments is XML over https. The instructions are carried in messages to a service agent running on the service delivery device. The service agent, which has a generic interface, communicates with the service drivers and instructs them to generate the necessary instructions for the hardware to implement an action requested by the central controller.

FIG. 2 is a block diagram showing the structure of an SDP 20. Hardware 21 might, for example, be a Cisco Pix firewall. A service driver 22 is written specifically for this hardware so that it can be configured by instructions received from service agent 23, which has a generic interface communicating with a central authority using a common language. The service drivers can be download from the central controller. They communicate with the local device in the appropriate device-dependent language, for example, Cisco IOS, SNMP etc.

The central controller 26 is a powerful directory-driven software platform attached to the NOC network 12 and exchanges XML messages with the service delivery point 20 via secure http over the IP network 16. The central controller 26 stores “policies” or sets of attributes defining the configuration of the service delivery points 20. This eliminates the need to set up a dedicated management network between the NOC 10 and each of the customer locations in order to manage the SDPs. The controller 26 automates the definition, activation, billing aggregation and management of value-added services for consumers and businesses.

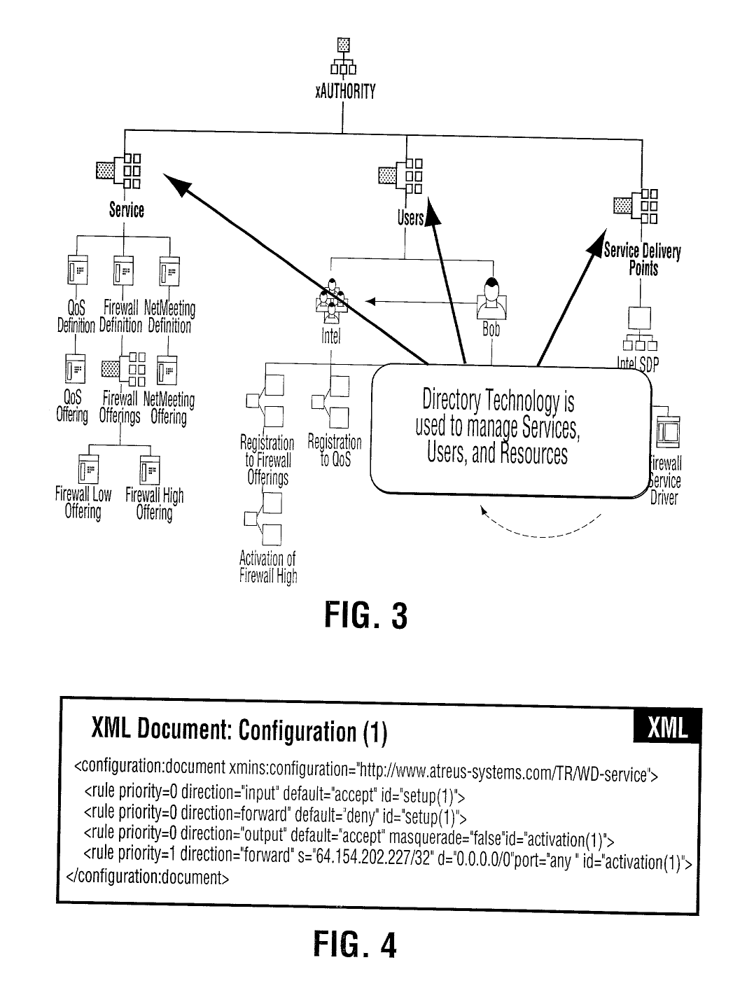

As shown in FIG. 3, the central controller includes a directory structure using LDAP (Lightweight Directory Access Protocol) that maps to the network resources, namely services, users, and service delivery points which form the root components of the LDAP scheme. “Policies” or sets of attributes relating to network resources are stored in the LDAP directory. The controller 26 can manipulate the policies without the need for an understanding of the details of each policy and what they mean in terms of the specific hardware to which they relate.

Policy attributes for each network element form a “service definition” for that element. For example, in the case of a firewall, the service definition might include attributes, such as source address and port, destination address and port, protocol, and “accept/deny”. Any particular service offering groups policy attributes in a way that appeals to the subscribers.

An SDP may also provide a service portal, which delivers the customer experience and is normally in the form of a web page accessible to the customer. Service portals can be customized to address the needs of specific subscribers or groups of subscribers. Using the service portal, the customer can select services of interest. The selected services are then set up by the central controller, which exchanges messages with the service agent 24 at the customer's SDP.

It will be instructive to consider how a service provider wishing to offer a new service to its customers would proceed in accordance with the invention. The first step is to obtain or develop the necessary service driver for the service. As noted above this runs on the SDP and mediates between the network or computing devices at the SDPs 20 and the central controller 26 to implement the policies commanded by the central controller 26. The service driver, which is a collection of software components, may include a default service configuration, service activation workflow, management user interface (UI) pages and customer portal links. The service driver software creates an interface on the SDPs that enables the controller 26 to control the remote devices using a generic instruction set. In the alternative, the service drivers can be located at the controller site, but this solution is less convenient in that communications with the remote device must take place from the controller site using the specific instruction set understood by the remote device. The preference is to place the service drivers

Once the service drivers have been obtained, the necessary software modules are installed in the central controller 26. A new Service Definition is entered in the LDAP directory, which can be viewed by the Service Provider Administrator on the central controller 26. At this point, the Service Definition can be associated with an SDP and used to create Service Offerings to customers or groups of customers.

Using a Firewall Service as an example shows how a service provider makes a Security Offering available to corporate users. The service example might be called “Firewall Offering” and come in two variants, “Firewall High” and “Firewall Low”. “Firewall High” is a restrictive offering that allows very little to pass through the firewall. “Firewall Low” is a more permissive offering, enabling the transmission of a variety of protocols through the firewall.

FIG. 4 shows the effect of the installation of the Firewall Service Driver on the LDAP directory. The newly installed Firewall Service Definition, shown in heavy outline, is installed under the root for services and forms the base building block that will be used by all Firewall Service Offerings when communicating with the firewall service driver.

It will be appreciated that the policy information in the Service Definition is abstract, and can be applied equally well to firewalls from a wide variety of vendors. The service drivers mediate with vendor specific instruction sets. As a result the same security definition can be used as the basis for offerings sold to subscribers who are served by a variety of network architectures, in sites that are served by different sizes, revision levels, or vendors of firewall technology. This is particularly valuable in an environment where thousands of users may require a policy change quickly in a very diverse environment. An example of this would be the requirement to update firewall policy in response to a hacker threat.

Having installed the Service Definition in the LDAP directory of the central controller 26, the next step is to configure the (SDPs) 20. The SDPs communicate with the central controller 26 using the service delivery agents. Prior to downloading the service driver, an administrator at the central controller first logs on to the SDP and defines its name and IP address.

If desired, SDPs can be grouped in the controller. Grouping can be based on geographic location, customer site, etc. and the Service Provider has the flexibility to create as many group levels as desired. By creating SDP groups, actions can be performed to individual SDPs or to SDP groups, which in turn performs the action to all SDPs contained within the group—with a single click of the mouse.

Using a management user interface for the controller 26, the service provider can assign service drivers to the appropriate SDPs 20. For example, if the SDP is a Cisco PIX firewall, the Cisco PIX Firewall Service Driver is assigned to that SDP. The Service Driver SDP-related software can either be downloaded directly onto the device, reside on a separate device (typically collocated with the device or server being managed), or remain on the central controller.

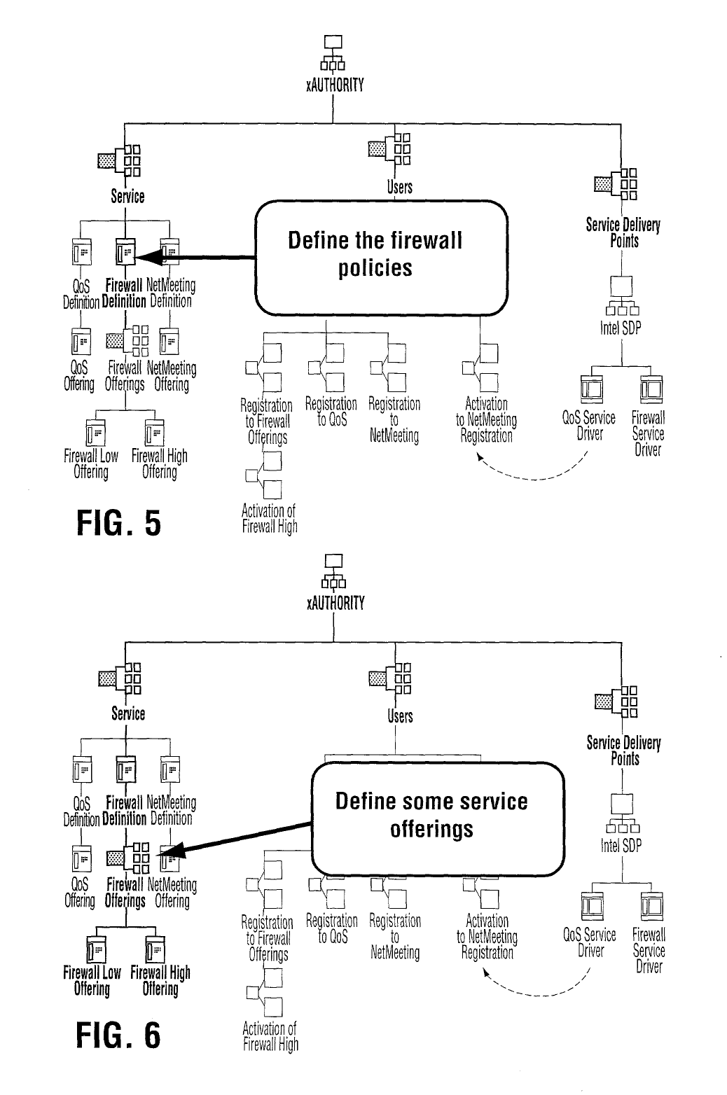

The assignment of a Service Driver to a Service Delivery Point generates an XML configuration document. This configuration document is modified by activation and deactivation of services. A sample configuration document is shown in FIG. 5. In this example, different rules have been applied to the firewall identified by www.atreussystems.com/TRIWD-service. Each rule has an identity tag that identifies the source of the rule. In this example, three of the rules come from “setup(1)” and one from “activation(1)”.

When the service drivers are installed on physical equipment, it is of course necessary to reflect the changes in the LDAP directory on the central controller. FIG. 5 shows in solid outline the addition of the new services, Firewall Low offering and Firewall High Offering under the subdirectory Firewall Offerings of the root Services, and the SDP branch of the tree structure is modified to reflect the presence of the firewall service driver on the remote device.

Once the service driver has been downloaded, the central controller 26 can communicate and control the associated device by exchange of messages. Such communications include receiving statistics and usage events, setting parameters, backing up and restoring the device configuration and monitoring the status of the device settings.

A similar approach can be used to created service offerings. Such offerings might include billing policies, QoS etc. that are made available to customers through an existing portal. New service offerings are derived from either a service definition or another preexisting service offering. The new service offering inherits all the of the configuration and policy information from a particular service definition are it default value. The service provider is able through the user interface at the central controller 26 make any appropriate modifications or customizations to the new service offering's inherited configuration and policies.

FIG. 6 shows the necessary changes to the LDAP database. In this case, it is only necessary to make the appropriate entries in the service branch of the directory. These service offerings are stored in the LDAP directory as XML documents, where they can be queried by the central controller as required for activation and management of specific service instances.

The service offering applies specific values (or references to service specific values) of the policy attributes in the service definition. The service offering is a series of policy attributes that is stored in the LDAP directory for application to a large number of individual subscribers. The controller 26 provides a configuration form on its user interface, through which service provider administrators can make any modifications or customizations to the new Service Offering's inherited configuration and policies.

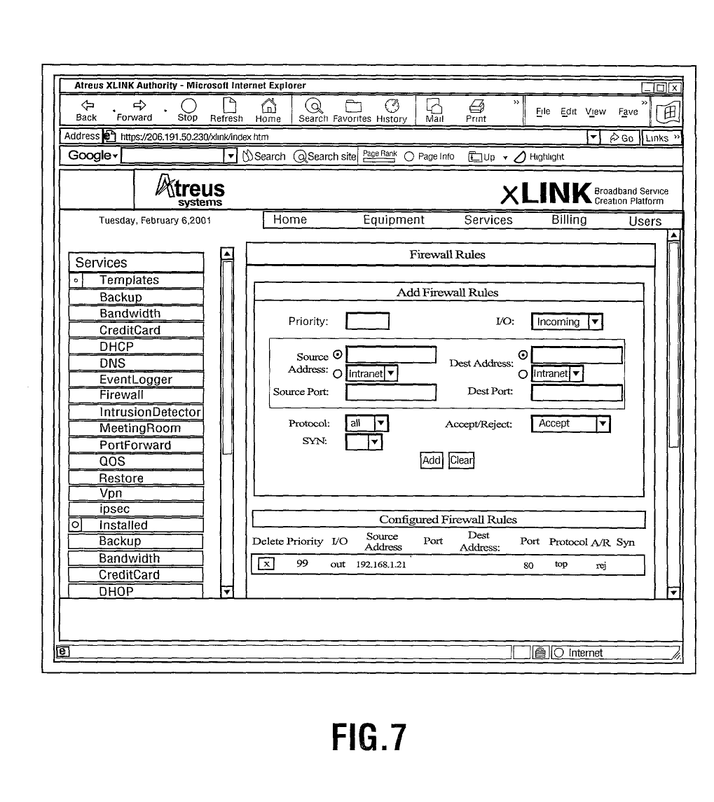

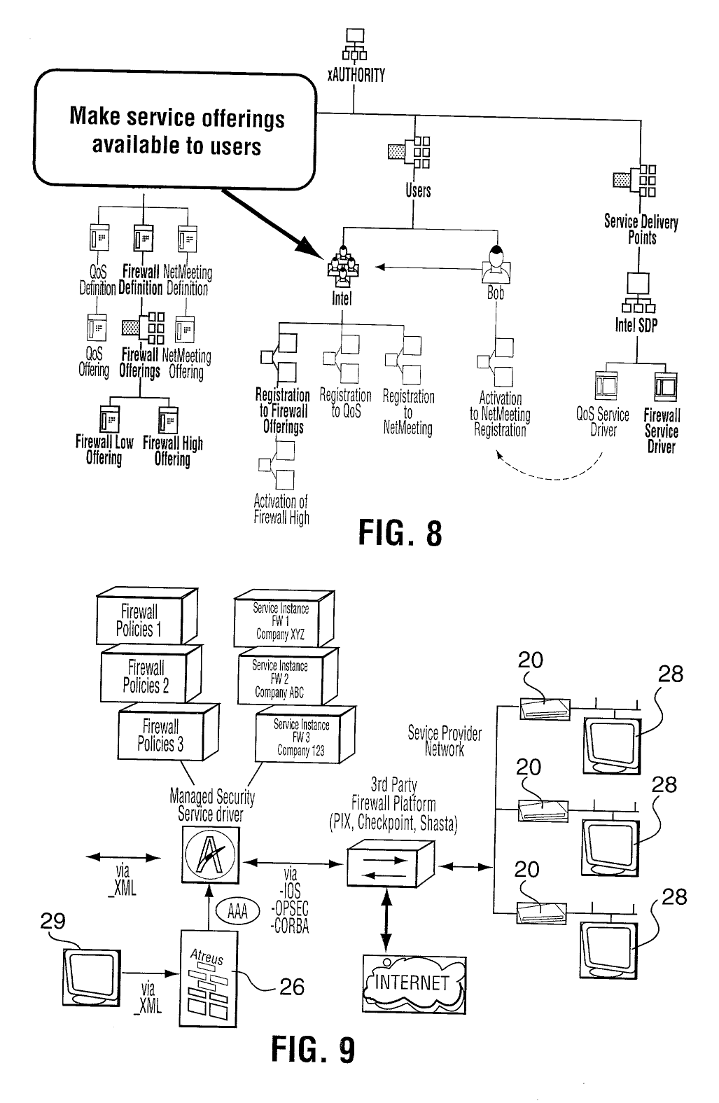

FIG. 7 shows a typical form for the configuration form for a firewall service. In this example the Firewall definition specifies the policy attributes for each firewall offering. They are Priority, I/O, Source Address, Destination Address, Source Port, Destination Port, Protocol, Accept/Reject, and SYN. Each of these is an element in the XML definition of the Service. The “Installed” tab on the left of this user interface allows this service to be assigned to a number of SDP's.

The central controller 26 also stores information about customers in its LDAP directory. The directory can be populated with customer information either from the controller user interface by the Service Provider Administrator or from another system via the an API (Application Programming Interface) provided in the central controller. It will be appreciated that customers can be grouped in any number of levels as desired by the Service Provider, for example by region or industry.

Any operation that is performed on an individual customer can also be performed on a customer grouped. When an operation is performed on a group, all of the customers within the group are affected. FIG. 7 shows the groupings of customers in the LDAP directory.

Once Service Offerings have been configured and customer groups created, Service Providers can make Service Offerings available to customers using the controller interface. Service Offerings assigned to a customer are then displayed on the customer's service portal and available for subscription. The flexibility of this feature gives service providers the means to group customers based on common interests and deliver targeted services to those groups in a simple, scalable and economical manner.

FIG. 9 shows how distinct Service Offerings can be created from the same Service Definition and provided to different customers. The customers 28 have their own portal interfaces, typically web pages, provided by local SDPs 20. The customers are presented with service options through their respective portals and can make requests which are passed to the central controller 26. This then creates instances of the various service offerings to be run on the SDPs.

Service Activation is carried out in steps: Service Registration and Service Activation. Service Registration involves a user or business subscribing to a Service Offering (e.g. NetMeeting). This transaction would typically include the customer selecting the level of service that they desire and paying a monthly subscription fee to make the service available for them to use.

The action of a user logging on to the service portal and using a service (e.g. joining a NetMeeting) constitutes the Service Activation step. The central controller gives the Service Provider the flexibility to generate a billing event on one or both of these steps.

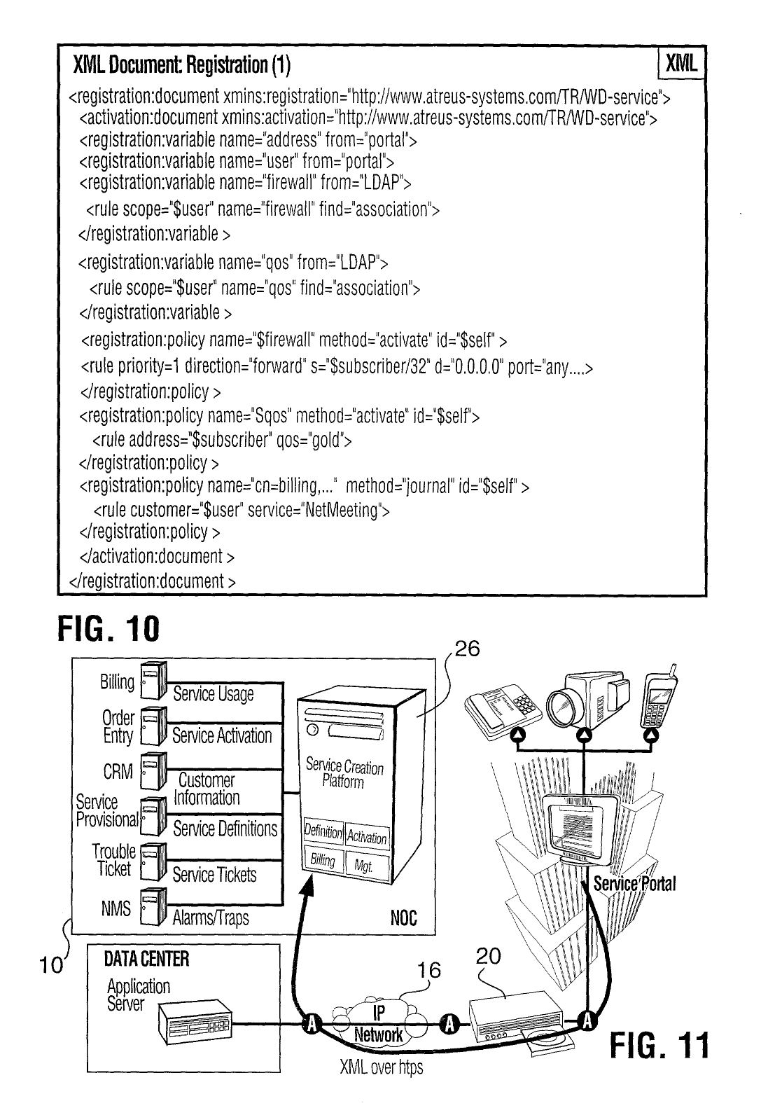

Once a Service Offering has been assigned to a customer or customer group, provided that a user has the permission to subscribe to a service, the service offering is advertised on the customer service portal. Upon registration, the central controller creates a registration policy document and stores it in the directory with the associated customer. A sample registration document is shown in FIG. 10.

This Service Instance enables the Service Provider to modify the service delivered to an individual customer, without affecting other customer services. It also provides the ability to modify the parent service offering and have the changes propagated to all of the customers that have subscribed to the service.

In some cases (e.g. Firewall Service) there is no distinction between service registration and activation. This is typically true for “always on” services. Once the customer registers for the service, it is automatically activated (e.g. the configuration is sent to the firewall). Other services (e.g. NetMeeting) have requirements for distinct registration and activation steps. A company may choose to purchase the NetMeeting service, but an employee may not need to join a NetMeeting until a later date. In this case, an additional activation step is required to authenticate the user when they log on and perform the necessary actions to deliver the content or application.

Each service request, for both registration and activation, is sent via XML from the Service Provider's portal server to the central controller. The controller interprets the request by passing the service parameters through the pre-defined rules associated with the Service Offering and stored in the LDAP directory. These rules could be as simple as sending a configuration request to a Firewall to allow or deny access to specific ports, or it could be more complex as in the case of an Application Service where the central authority may have to pass access information to the application server, set up a VPN between the user and application server, punch through a firewall and modify the available bandwidth and QoS to the user.

FIG. 11 illustrates how a service activation request is sent from the service portal to the central controller via the Internet. The customer places the request on his service portal and this is passed via the SDP 20 to the central controller 26 which then creates an instance of the service for that customer.

In addition to giving the Service Provider the capability to offer targeted service to customer groups, the central controller gives business customer administrators the ability to control which employees have access to registered services. Through the customer administration portal, purchasing officers can create department groups within their organization. As with other group types in the controller 26, the operator has the flexibility to create any number of department and any number of group levels as desired.

For example, a business may purchase 20 licenses from a service provider to use NetMeeting. Rather than allowing any employee in the company to use this service, the customer administrator may choose to make a Sales department group and give NetMeeting access only to those employees in that group.

The controller 26 provides a central billing record aggregation function for the services defined in the system. Events are collected by the controller from a diverse set of network or computing devices made by multiple vendors using the common language and generic interface. This system attribute is enabled by the presence of Service Delivery Points in the network. Events collected via SDPs are correlated with the appropriate Service Offering Billing Policy and stored as XML records.

The Billing Policies defined for service offerings allow the service provider to bill customers for that service based on the following events, individually or in combination: Service Activation Events (occur when a service becomes available for customer use); Service Deactivation Events (occur when a service becomes unavailable for customer use); Service Registration Events (occur when a service becomes available for use by a specific subscriber, within a customer group); Service Deregistration Events (occur when a service becomes unavailable for use by a specific subscriber, within a customer group); and Service Usage Events (occur whenever a service is used).

Prior to storing the billing record, the central controller 26 applies rating to logged events based on the policies defined in the Service Offering. Records can be pulled from the controller by one or more billing systems. This feature enables service providers to act as a service distribution channel and seamlessly invoice their customers for services operated either by the provider or the provider's partner.

Once a Service Offering has been deployed and activated, the task of monitoring, and maintaining that Service Offering still remains. This charge is handled by the controller's service management capabilities. The controller interface 29 (FIG. 9) provides the service provider with the following service management related functionality: Central Service Configuration; Central Service Software Upgrades; Central Service Startup and Shutdown; Central Service Monitoring; Central Software Upgrades; and Central Service Configuration.

The controller interface 29 provides the service provider with an interface for remotely modifying the configurations of existing service offerings from a central location. Modifying the configuration of an existing Service Offering, and committing the changes, results in the new configuration being automatically propagated down to all affected SDPs.

The controller interface 29 also provides the Service Provider with an interface for remotely upgrading the software components of existing service offerings from a central location. The actual upgrades of the software do not occur until the service provider invokes an installation of the service offering on each of the affected SDPs. Until such time, the installation status for the Service Offering on each SDP will indicate that an upgrade is required.

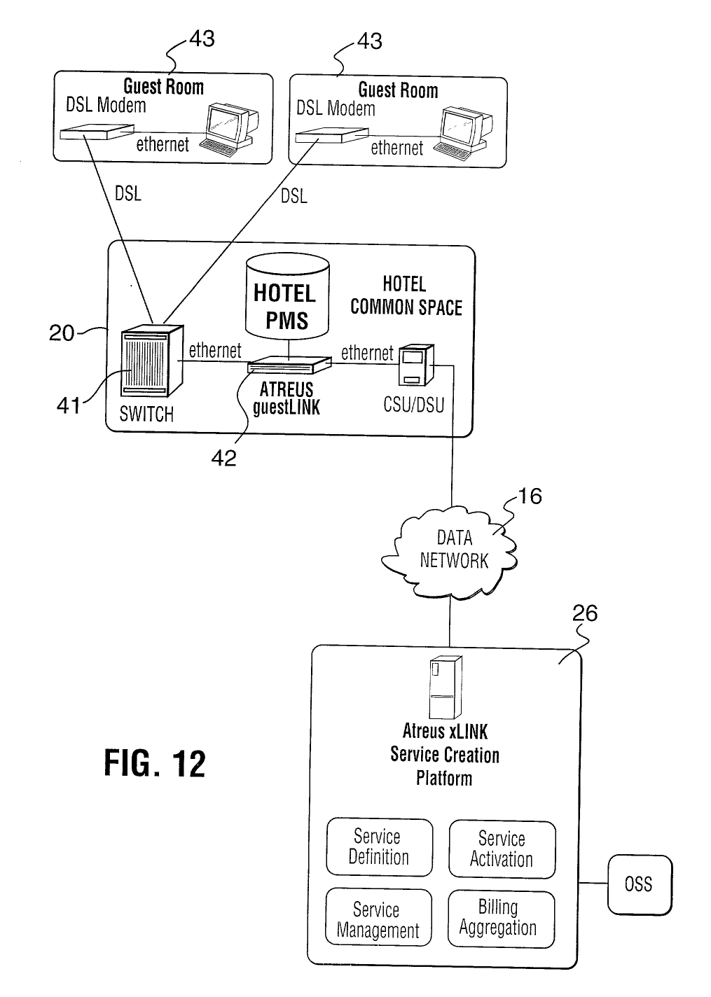

In a preferred embodiment, an SDP can include a subcontroller at the remote site communicating over the Internet with the central controller 26 located at the ISP's POP. FIG. 12 shows such an embodiment. Central controller 26 communicates over data network 26, such as the internet, with SDP 20 that includes a switch an subcontroller 42. In this example, which is designed for a hotel, switch 41 connects the subcontroller 42 to hotel guest rooms 43. The subcontroller 42 communicates over the network using XML over https with the central controller 41, but also provides a remote platform for the local tenant, in this case the hotel administration, to launch a number of services for the local market. In the case of a hotel, this could include broadband Internet access, but in additional such local services as video-on-demand for use only within the hotel premises, intrusion detection, guest registration, online gaming, temporary hotel email and the like.

As noted above, the service offerings are defined as XML documents. These are generated using XSL, which is a language for expressing stylesheets. It consists of three parts, namely XSL Transformations (XSLT), a language for transforming XML documents; XML Path Language (XPath), an expression language used by XSLT to access or refer to parts of an XML document (XPath is also used by the XML Linking specification); and an XML vocabulary for specifying formatting semantics (XSL Formatting Objects). An XSL stylesheet specifies the presentation of a class of XML documents by describing how an instance of the class is transformed into an XML document that uses the formatting vocabulary.

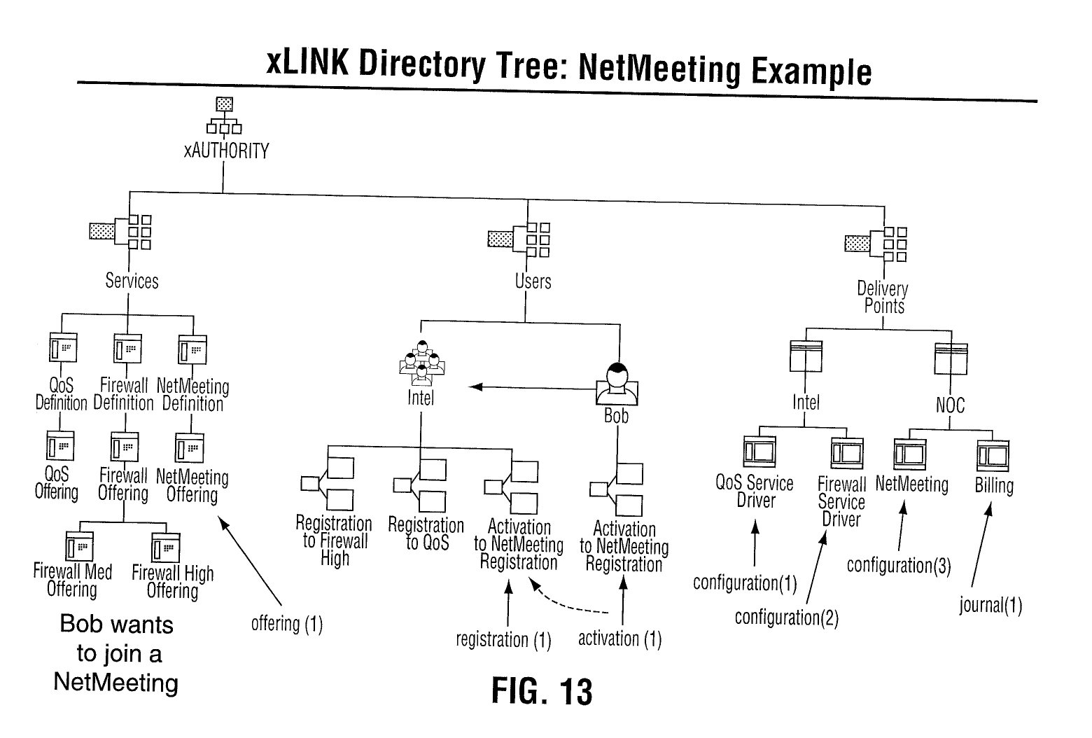

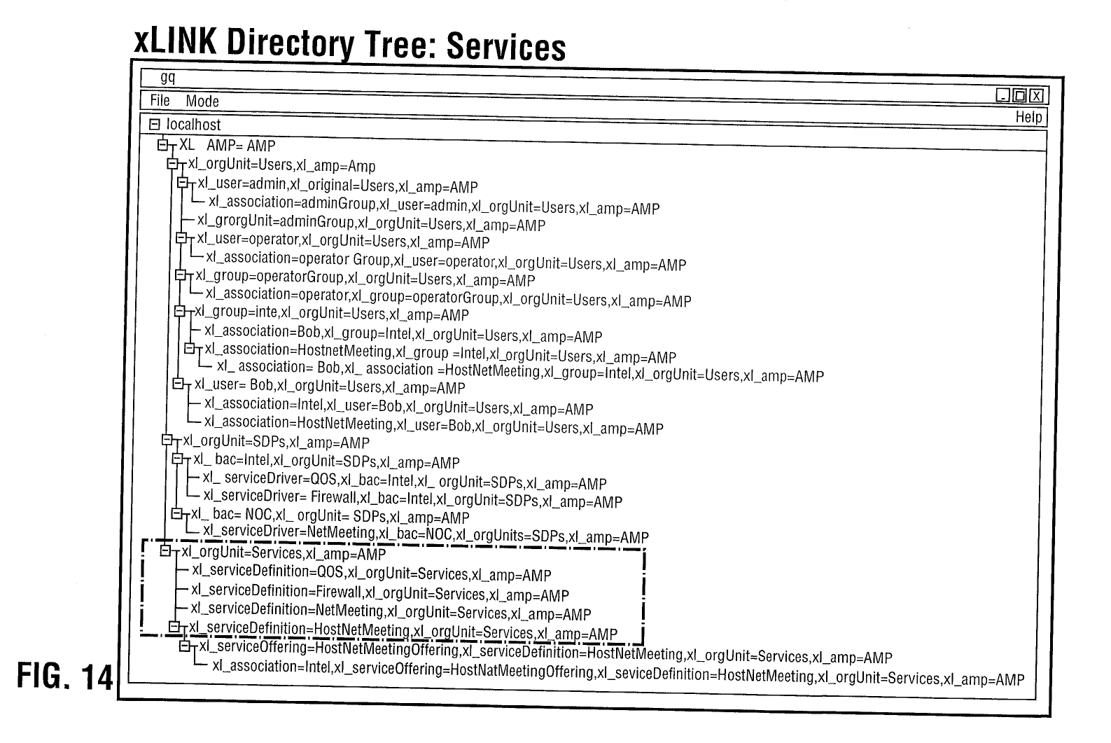

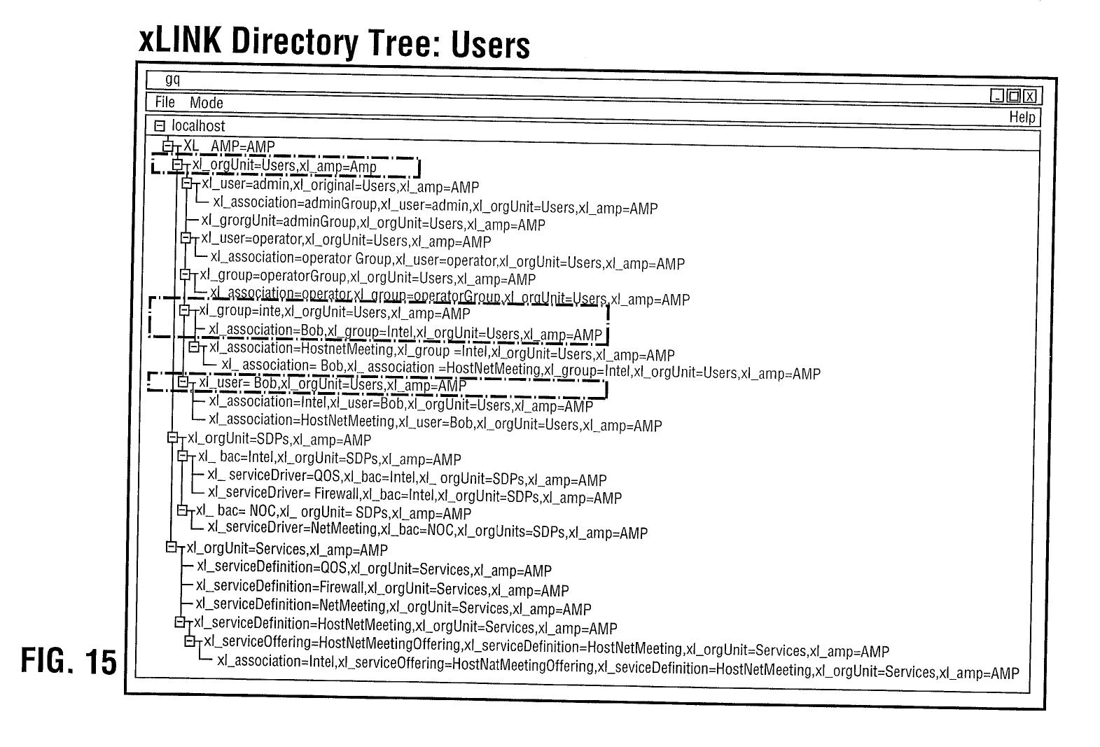

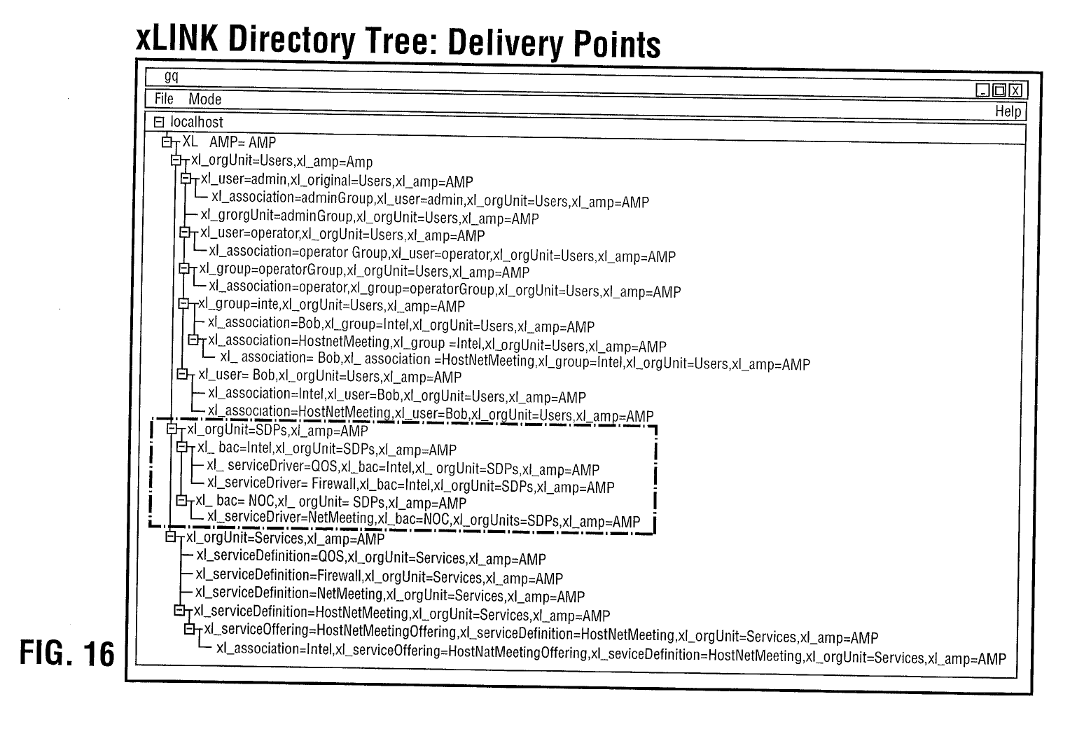

A specific example the use of the invention will now be described with respect to the establishment of a NetMeeting session. First the service provider must define and publish NetMeeting as a service offering to the user in question, in this case Bob, by including it in the LDAP directory shown in FIG. 13. Next, the administrator must register the services. Finally, Bob must activate the requested service. The structure of actual directory trees defining services, users, and delivery points is shown in FIGS. 14 to 16.

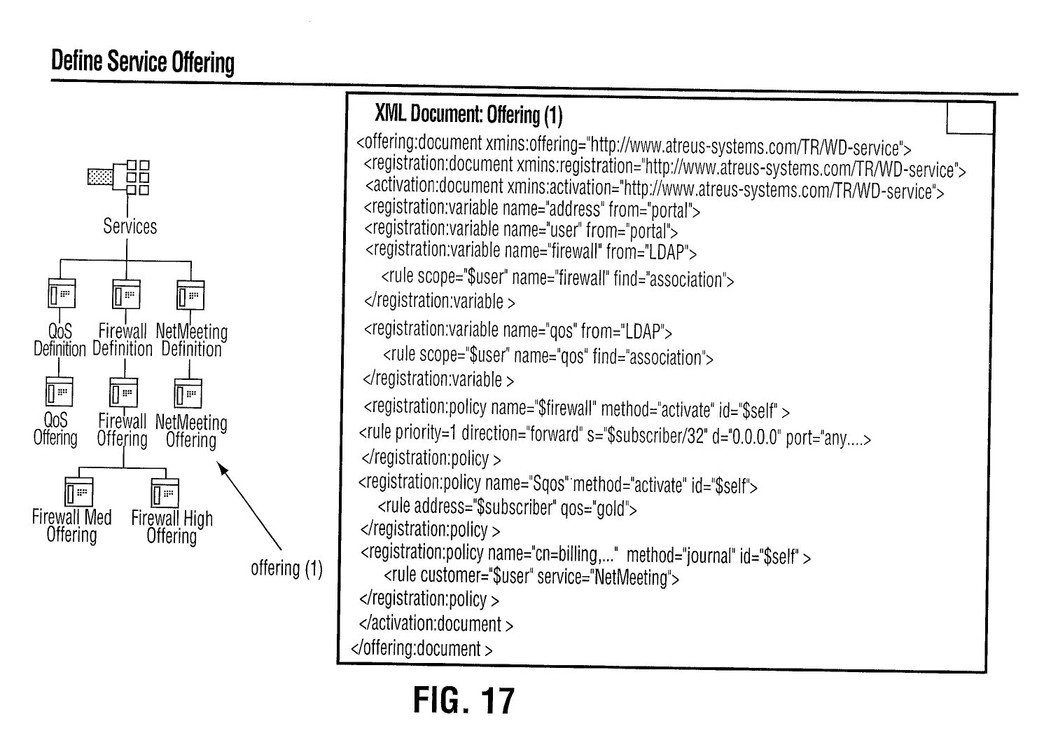

In this example, the XML document defining the service offering is shown in FIG. 17. When this document is present in the LDAP directory, the NetMeeting service offering is published to Bob, i.e. it is made available to him. The XML document shown in FIG. 17 is derived from an XSL style sheet setting out its presentation, and which generates the actual XML document based on the data provided for the specific service offering.

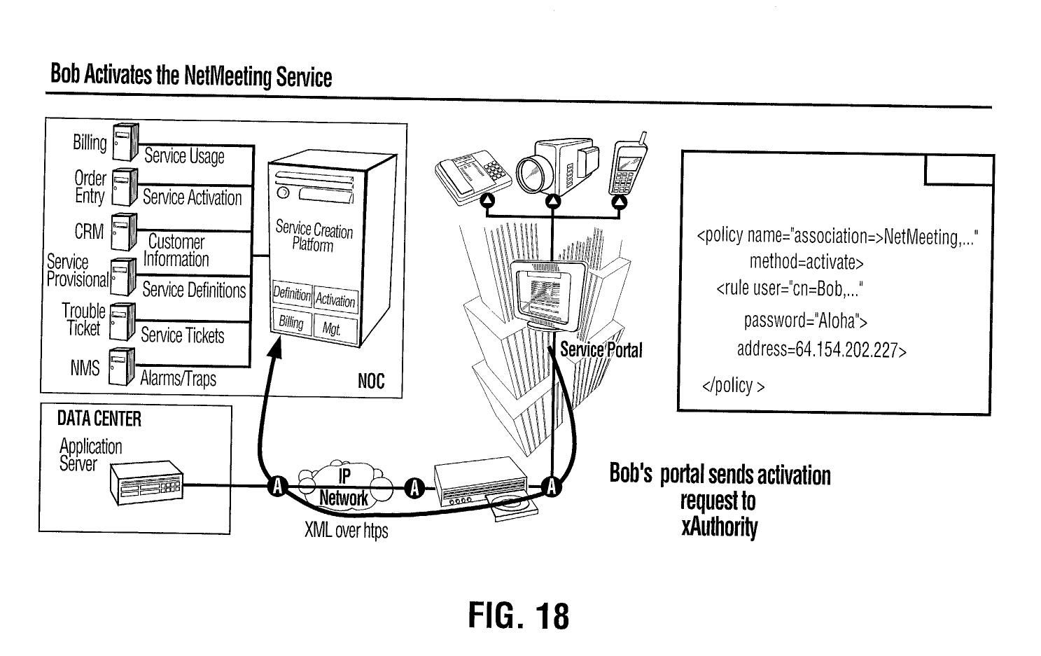

Once the service offering has been defined and published as available to Bob, Bob can activate the service. As shown in FIG. 18, Bob must first send an activation request to the central authority. This is achieved by sending a short XML document specifying his address, user name and the like (see inset in FIG. 18), by secure https over the network to the central authority.

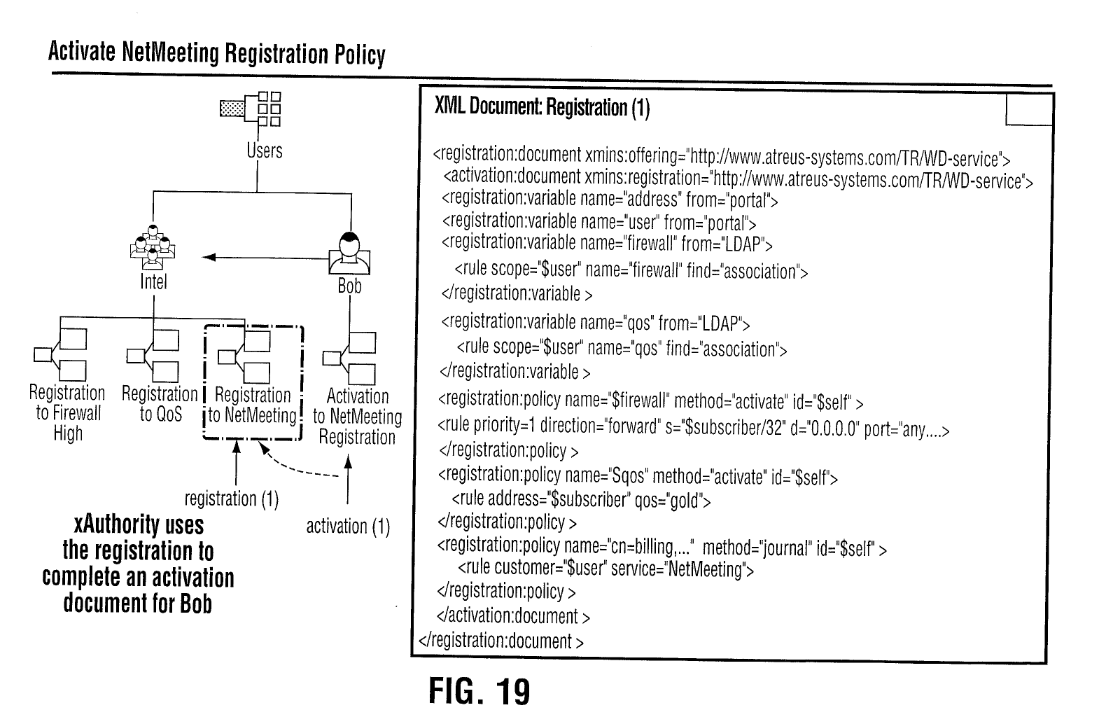

As shown in FIG. 19, the receipt of an activation request at the central authority results in registration to complete an activation document for Bob. This is also in the form of an XML document, which registers Bob as a participant in the requested NetMeeting session. The registration document, which is shown in FIG. 10, contains the details pertaining to Bob's participation in the conference and is again generated with the aid of an XSL stylesheet.

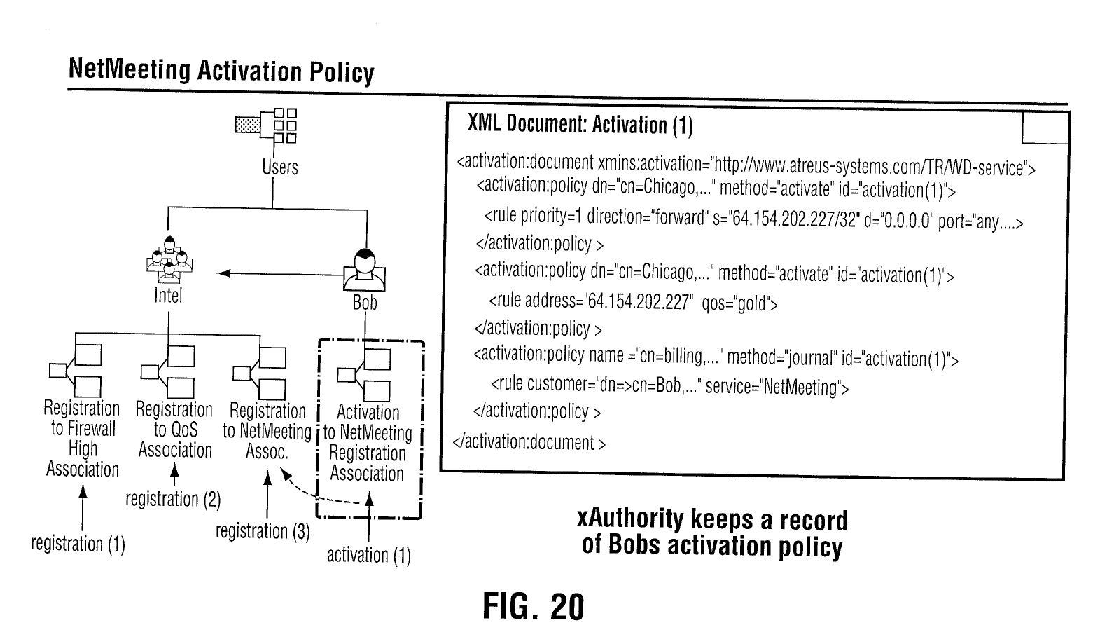

FIG. 20 shows the generation of an activation document that keeps a record of Bob's activation policy

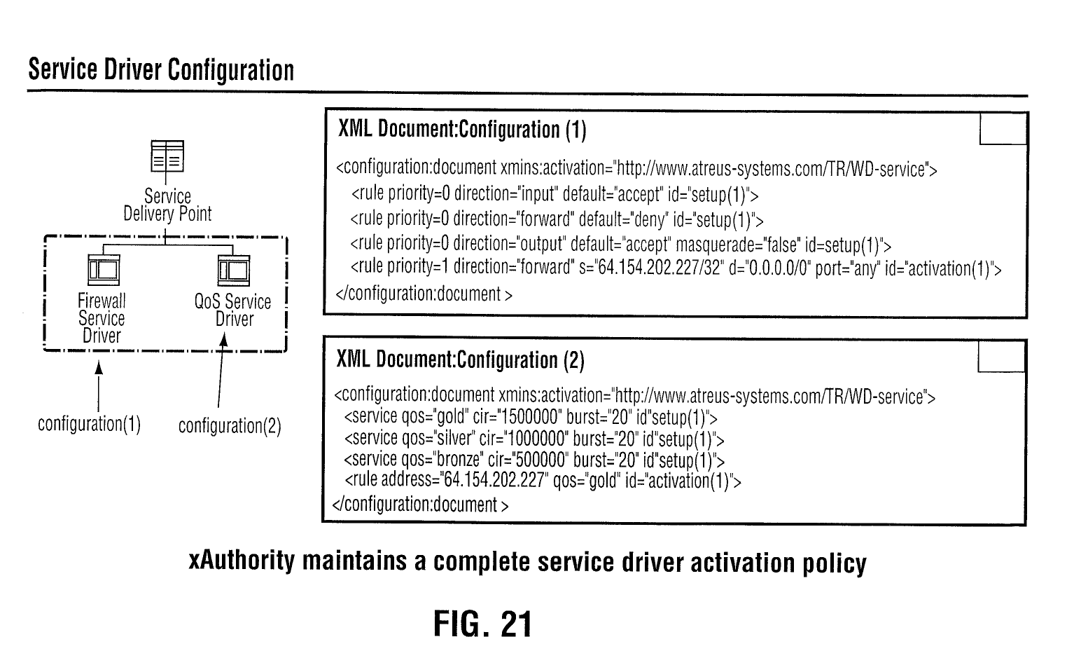

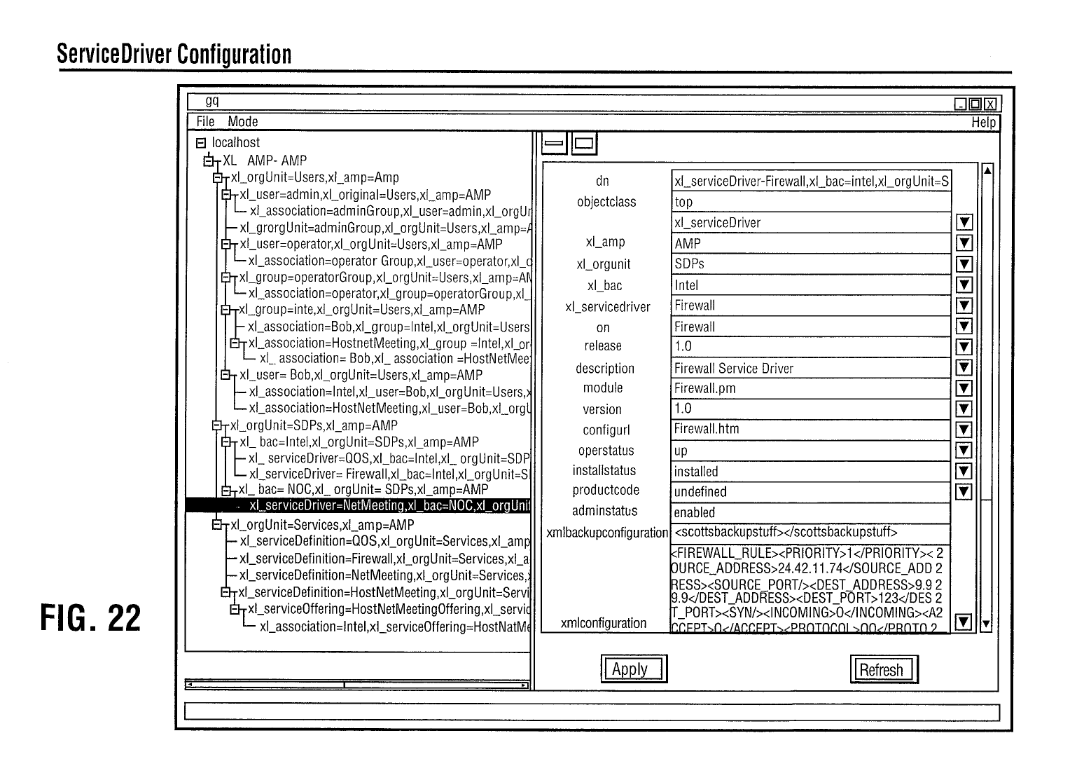

FIG. 21 shows an example of a service driver configuration, also defined in terms of XML documents. Configuration 1, which is the same as shown in FIG. 4, defines the firewall service driver. Configuration 2 defines the Quality-of-serivce (Qos) driver. A specific example of a service driver configuration is shown in FIG. 22. This policy is sent to a service driver as an XML document by secure http, and in turn the service driver activates the hardware device by translating the policy defined as an XML document into the appropriate protocol for the managed element, for example a CISCO router.

The entire configuration thus takes place within the LDAP directory using a common XML language until the very last step wherein the policy is sent over the http link to be implemented in the appropriate protocol for managed element. As noted above, the service driver can reside at the central authority, in which case the appropriate instructions in the hardware protocol must be sent over the network, although this is not the preferred option.

The present invention gives service providers, whether they be service a regional or purely local market, as in the case of a hotel, a means by which they can develop new services or bundles of services that are targeted to specific markets or groups of customers and to deliver and manage those services in an efficient, repeatable and scalable manner. It further provides a system which allows for the implementation, management and billing of services from a central location, without the need to have service technicians attend at user premises. This is accomplished using a systematic approach involving: (1) definition of services targeted to groups of subscribers; (2) activation and deactivation of services to specific subscribers or groups of subscribers; (3) billing of services; and (4) management and monitoring of services.

The automated centralized broadband service creation platform and distributed service delivery points or agents together can control computer and network hardware devices as well software applications over a broadband network. This allows service providers to add new services or update existing ones quickly using their broadband networks without the need to send service technicians to the customer premises in order to configure or reconfigure customer premise equipment or software.

What is claimed is:

1. A system for managing the delivery of services over a network, comprising:
a plurality of distributed network entities configurable to deliver specified services;
a plurality of service agents operable to configure one or more of said distributed network entities associated therewith in response to messages received at a generic interface; and
a central controller for generating said messages using a common instruction set for all said network entities, said central controller including a database storing attributes defining the configuration of said network entities.

2. A system as claimed as claim 1, further comprising service drivers associated said network entities and responsive to instructions from said service agents to generate hardware specific commands to configure said network elements in accordance with instructions from said central controller.

3. A system as claimed in claim 2, wherein said attributes are stored in said database in a directory structure mapped to said network entities.

4. A system as claimed in claim 1, wherein said messages are defined in XML language transported over secure http.

5. A system as claimed in claim 1, further comprising a service portals generated by said SDPs to present service offerings to local customers on the basis of policies stored in said database at said central controller.

6. A system as claimed in claim 5, wherein said service portals are in the form of web pages.

7. A system as claimed in claim 1, further comprising a user interface connected to said central controller and presenting a form-based screen to permit entry of configuration information into said database.

8. A system as claimed in claim 1, wherein said entities are servers for locally delivering broadband services to customers connected thereto.

9. A system as claimed in claim 1, wherein at least some of said network entities include hardware devices providing specific services.

10. A system as claimed in claim 9, wherein said network entities include specific service offerings defined in said central controller.

11. A method of controlling the delivery of services to customers over a network, comprising the steps of:
providing a plurality of distributed network entities capable of providing services to customers connected thereto;
providing at each of said distributed network entities a service agent responsive to commands using a common instruction set received at a generic interface to configure said network entities;
providing a central controller for generating said commands to configure said network entities;
storing in a database associated with said central controller policy attributes determining the configuration of said network entities; and
sending said commands to said network entities to configure said network entities in accordance with policies established in said central controller.

12. A method as claimed in claim 11, wherein said commands are transported over the network.

13. A method as claimed in claim 1, further comprising providing at said network entities service drivers responsive to instructions from said service agents to generate entity specific instructions to configure said network entities.

14. A method as claimed in claim 13, wherein said service drivers are stored on said central controller and download to said network entities over said network.

15. A method as claimed in claim 11, wherein said commands are transported in messages using a common language and protocol.

16. A method as claimed in claim 15, wherein said messages are transported over said network as XML documents using secure http protocol.

17. A method as claimed in claim 11, wherein said database has a directory tree structure having components of said directory structure mapped to network resources.

18. A method as claimed in claim 17, wherein said directory structure includes branches associated respectively with customers, services, and hardware entities offering service portals for customers.

19. A method as claimed in claim 18, wherein said service portals comprise web pages stored on said hardware entities and providing forms to permit users to make service requests, said service agents send said service requests to the central controller via the generic interface, said central controller updates said database in response to said service requests, and said central controller then initiates an instance of a requested service for a user how has requested the service.

20. A method as claimed in claim 11, wherein said network elements include software elements offering network services.

21. A method as claimed in claim 11, wherein said central controller additionally communicates with a billing server to provide billing services.

22. A method of managing a plurality of network elements to define service offerings from a central location, comprising:
storing in a computer a model identifying service offerings, users, and delivery points;
defining within said model specific service offerings using a common language;
receiving service requests for offerings from identified users in said common language and inputting said requests into said model;
configuring said model using said common language to implement said service requests within said model; and
forwarding instructions in said common language from said model to a service drivers associated with said network element, said service driver translating said instructions in said common language into hardware specific instructions associated with said network elements in order to implement said service requests.

23. A method as claimed in claim 22, wherein said model is implemented as a directory structure having branches associated respectively with said service offerings, users, and delivery points.

24. A method as claimed in claim 22, wherein said common language is XML.

25. A method as claimed in claim 25, wherein said XML documents within said model are generated from XSL style sheets.

25. A method as claimed in claim 24, wherein said instructions are forwarded to said service drivers using a secure protocol.

26. A method as claimed in claim 25, wherein said secure protocol is https.
